(19) United States
(12) Patent Application Publication
(10) Pub. No.: US 2010/0085673 A1
(43) Pub. Date: Apr. 8, 2010

(54) OVER-VOLTAGE AND UNDER-VOLTAGE PROTECTION SYSTEM

(75) Inventor: CHIEH-HSUAN LEE, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXNUM TECHNOLOGY CO., LTD., Tucheng City (TW)

(21) Appl. No.: 12/269,046

(22) Filed: Nov. 12, 2008

(30) Foreign Application Priority Data
Oct. 6, 2008 (CN) 200810304739.6

(51) Int. Cl. H02H 3/20; H02H 7/09; H02H 7/12

(52) U.S. Cl. 361/90; 361/33; 361/18

(57) ABSTRACT

An over-voltage and under-voltage protection system for protecting an electrical device includes a comparison device, a signal controller, a switch controller, and a switch. The comparison device receives an input voltage and compares the input voltage with a predetermined voltage. If the input voltage is greater than the predetermined voltage, the comparison device outputs an over-voltage signal to the switch controller via the signal controller. If the input voltage is less than the predetermined voltage, the comparison device outputs an under-voltage signal to the switch controller via the signal controller. The switch controller controls the switch to turn the electrical device off when the over-voltage or the under-voltage signals are received from the signal controller.

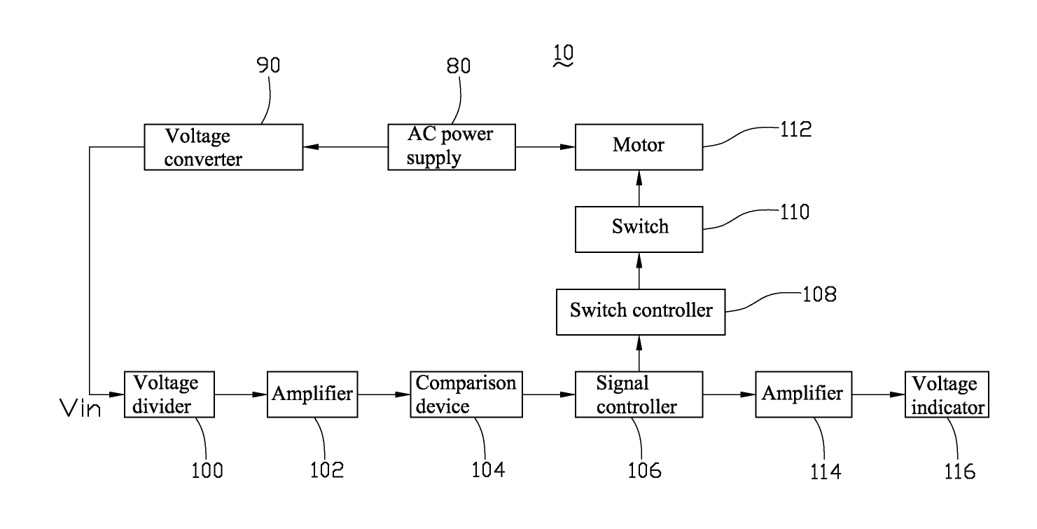

### BACKGROUND

1. Technical Field

The present disclosure relates to voltage protection systems and, particularly, to an over-voltage and under-voltage protection system.

2. Description of Related Art

Electrical devices, such as a motor, are designed to run normally at or near a specified standard voltage. However, the power supply system that powers a motor may provide voltages that are substantially higher or lower than the specified voltage the motor is built to operate under, these out-of-range voltages can damage the motor.

Therefore, it is desired to provide an over-voltage and under-voltage protection system to overcome the above described shortcomings.

### BRIEF DESCRIPTION OF THE DRAWING

The drawing is a block diagram of a first exemplary embodiment of the hardware structure of an over-voltage and under-voltage protection system.

### DETAILED DESCRIPTION

Referring to the drawing, an exemplary embodiment of an over-voltage and under-voltage protection system 10 for protecting an electrical device includes an alternating current (AC) power supply 80, a voltage converter 90, a voltage divider 100, two amplifiers 102 and 114, a comparison device 104, a signal controller 106, a switch controller 108, a switch 110, and a voltage indicator 116. In this embodiment, the electrical device is a motor 112, and the voltage indicator 116 can be a digital readout or some other devices capable of displaying voltage.

The AC power supply 80 is configured for supplying an AC voltage to the motor 112 and the voltage converter 90. The voltage converter 90 is configured for converting the AC voltage into a direct current (DC) input voltage Vin to be provided to the voltage divider 100. The voltage divider 100 is configured for dividing the DC input voltage Vin to provide a smaller voltage to the amplifier 102.

The amplifier 102 is configured for amplifying the voltage from the voltage divider 100 proportionally and outputting a first adjusted voltage to the comparison device 104. The comparison device 104 is configured for comparing the first adjusted voltage with a predetermined voltage. If the first adjusted voltage is greater than the predetermined voltage, the comparison device 104 outputs an over-voltage signal to the switch controller 108 via the signal controller 106. If the first adjusted voltage is less than the predetermined voltage, the comparison device 104 outputs an under-voltage signal to the switch controller 108 via the signal controller 106. If the first adjusted voltage is equal to the predetermined voltage, the comparison device 104 outputs a normal voltage signal to the switch controller 108 via the signal controller 106. The signal controller 106 is configured for receiving and outputting the over-voltage signal, the under-voltage signal, or the normal voltage signal. The signal controller 106 is further configured for converting the over-voltage, the under-voltage, or the normal voltage signals into a DC output voltage to be provided to the amplifier 114. The amplifier 114 is configured for amplifying the DC output voltage proportionally and outputting a second adjusted DC voltage to the voltage indicator 116 to be displayed.

The switch controller 108 is configured for controlling the switch 110 to turn the motor 112 off, when over-voltage or under-voltage signals are received from the signal controller 106.

The working principle of the over-voltage and under-voltage protection system 10 is described in detail as below under condition that the predetermined voltage of the comparison device 104 is, in this embodiment, 4 volts and amplifying factor of both the amplifiers 102 and 114 is 8. The voltage divider 100 is configured to output a voltage at ⅛ of the input voltage Vin. The principle is the same whether the motor 112 is off and is just being turned on, or is already running. If the motor 112 receives 400 volts AC, which in this embodiment is the desired voltage, then the DC input voltage Vin is 400 volts, so the output voltage of the voltage divider 100 is 0.5 volts, the first adjusted voltage of the amplifier 102 is 0.5*8=4 volts, that is, the first adjusted voltage is equal to the predetermined voltage. The comparison device 104 compares the first adjusted voltage of the amplifier 102 (4 volts) with the predetermined voltage (4 volts), the comparison device 104 outputs the normal voltage signal to the switch controller 108 via the signal controller 106, and the switch 110 turns on or remains on to either start the motor 112 or allow the motor 112 to continue running, whichever the case may be. The signal controller 106 converts the normal voltage signal into the DC output voltage to be provided to the amplifier 114. The amplifier 114 amplifies the DC output voltage 8 times to be provided to the voltage indicator 116.

If the motor 112 receives 200 volts AC, the DC input voltage Vin is 200 volts, the output voltage of the voltage divider 100 is 0.25 volts, the first adjusted voltage of the amplifier 102 is 0.25*8=2 volts, that is, the first adjusted voltage is less than the predetermined voltage. The comparison device 104 compares the first adjusted voltage of the amplifier 102 (2 volts) with the predetermined voltage (4 volts), the comparison device 104 outputs the under-voltage signal to the switch controller 108 via the signal controller 106, and the switch 110 turns off so that the motor 112 will not operate. The signal controller 106 converts the under-voltage signal into the DC output voltage to be provided to the amplifier 114. The amplifier 114 amplifies the DC output voltage by a factor of 8 and provides the amplified voltage to the voltage indicator 116.

If the motor 112 receives 800 volts AC, the DC input voltage Vin is 800 volts, the output voltage of the voltage divider 100 is 1 volt, the first adjusted voltage of the amplifier 102 is 1*8=8 volts, that is, the first adjusted voltage is greater than the predetermined voltage. The comparison device 104 compares the first adjusted voltage of the amplifier 102 (8 volts) with the predetermined voltage (4 volts), the comparison device 104 outputs an over-voltage signal to the switch controller 108 via the signal controller 106, and the switch 110 turns off so that the motor 112 will not operate. The signal controller 106 converts the over-voltage signal into the DC output voltage to be provided to the amplifier 114. The amplifier 114 amplifies the DC output voltage by a factor of 8 and provides the amplified voltage to the voltage indicator 116.

In a second exemplary embodiment, the amplifier 114 and the voltage indicator 116 are omitted from the over-voltage and under-voltage protection system 10 if no display is needed.

In a third exemplary embodiment, the voltage divider 100, the amplifier 102, the amplifier 114, and the voltage indicator 116 are omitted from the over-voltage and under-voltage protection system 10. Thus, the DC input voltage Vin of the voltage converter 90 can be directly provided to the comparison device 104.

In a fourth exemplary embodiment, the amplifier 114 is omitted from the over-voltage and under-voltage protection system 10. Thus, the signal controller 106 is configured for providing the over-voltage, the under-voltage, and the normal voltage signals to the switch controller 108.

In a fifth exemplary embodiment, the amplifiers 102 and 114, and the voltage indicator 116 are omitted from the over-voltage and under-voltage protection system 10. Thus, the voltage from the voltage divider 100 is provided directly to the comparison device 104.

It is to be understood, however, that even though numerous characteristics and advantages of the embodiments have been set forth in the foregoing description, together with details of the structure and function of the embodiments, the disclosure is illustrative only, and changes may be made in details, especially in matters of shape, size, and arrangement of parts within the principles of the embodiments to the full extent indicated by the broad general meaning of the terms in which the appended claims are expressed.

What is claimed is:

1. An over-voltage and under-voltage protection system for protecting an electrical device, comprising:
a comparison device configured for receiving an input voltage associated with a power driving the electrical device, and for comparing the input voltage with a predetermined voltage, outputting an over-voltage signal upon a condition that the input voltage is greater than the predetermined voltage, outputting an under-voltage signal upon a condition that the input voltage is less than the predetermined voltage;
a signal controller configured for receiving and outputting the over-voltage and under-voltage signals; and
a switch controller configured for controlling a switch to turn the electrical device off when the over-voltage or under-voltage signals are received from the signal controller.

2. The system of claim 1, further comprising a voltage indicator, wherein the signal controller is further configured for converting the over-voltage, or the under-voltage into a direct current (DC) output voltage to be provided to the voltage indicator.

3. The system of claim 1, further comprising an amplifier and a voltage indicator, wherein the signal controller is further configured for converting the over-voltage, or the under-voltage into a direct current (DC) output voltage, the DC output voltage is amplified proportionally by the amplifier and then is provided to the voltage indicator.

4. The system of claim 1, further comprising a voltage divider configured for dividing the input voltage, and outputting a smaller voltage to the comparison device.

5. The system of claim 1, further comprising a voltage divider and an amplifier, wherein the voltage divider is configured for dividing the input voltage, and outputting a smaller voltage to the amplifier, the amplifier is configured for amplifying the smaller voltage proportionally, and outputting an adjusted voltage to the comparison device.

6. The system of claim 1, further comprising a voltage converter, wherein the power driving the electrical device is an alternating current (AC) power, the voltage converter is configured for converting the AC power into the DC input voltage.

7. The system of claim 1, wherein the electrical device is a motor.

8. An electrical device comprising an over-voltage and under-voltage protection system for protecting the electrical device, the protection system comprising:
a comparison device configured for receiving an input voltage associated with a power driving the electrical device, and for comparing the input voltage with a predetermined voltage, outputting an over-voltage signal upon a condition that the input voltage is greater than the predetermined voltage, outputting an under-voltage signal upon a condition that the input voltage is less than the predetermined voltage;
a signal controller configured for receiving and outputting the over-voltage and under-voltage signals; and
a switch controller configured for controlling a switch to turn the electrical device off when the over-voltage or under-voltage signals are received from the signal controller.

9. The protection system of claim 8, further comprising a voltage indicator, wherein the signal controller is further configured for converting the over-voltage, or the under-voltage into a direct current (DC) output voltage to be provided to the voltage indicator.

10. The protection system of claim 8, further comprising an amplifier and a voltage indicator, wherein the signal controller is further configured for converting the over-voltage, or the under-voltage into a direct current (DC) output voltage, the DC output voltage is amplified proportionally by the amplifier and then is provided to the voltage indicator.

11. The protection system of claim 8, further comprising a voltage divider configured for dividing the input voltage, and outputting a smaller voltage to the comparison device.

12. The protection system of claim 8, further comprising a voltage divider and an amplifier, wherein the voltage divider is configured for dividing the input voltage, and outputting a smaller voltage to the amplifier, the amplifier is configured for amplifying the smaller voltage proportionally, and outputting an adjusted voltage to the comparison device.

13. The protection system of claim 8, further comprising a voltage converter, wherein the power driving the electrical device is an alternating current (AC) power, the voltage converter is configured for converting the AC power into the DC input voltage.

14. The protection system of claim 8, wherein the electrical device is a motor.
